(19) United States
(12) Patent Application Publication
(10) Pub. No.: US 2025/0305859 A1
(43) Pub. Date: Oct. 2, 2025

(54) INDUSTRIAL TRANSMITTER HOUSING AND MOUNT

(71) Applicant: Rosemount Inc., Shakopee, MN (US)

(72) Inventors: Greg E. GINDELE, Maple Lake, MN (US); Cory M. ROBINSON, Mayer, MN (US); Nathan K. HOLM, Mound, MN (US); Brandon L. SWICK, Eden Prairie, MN (US); Ryan C. TARRAS, Savage, MN (US); Hun CHHUOY, Savage, MN (US)

(21) Appl. No.: 18/622,219

(22) Filed: Mar. 29, 2024

(51) Int. Cl. G01D 11/24; H04L 67/12; H04Q 9/00

(52) U.S. Cl. CPC G01D 11/245; H04Q 9/00; H04L 67/12

(57) ABSTRACT

An industrial transmitter includes a lower housing having a recess configured to receive an electronics module, the lower housing also having at least one mounting feature formed integrally therein. An electronics module is disposed within the recess. A cover is coupled to the lower housing to hermetically seal the electronics module within the lower housing and the cover. An transmitter includes an inline housing having a first end and a second end, the inline housing having an integral mounting feature configured to receive a captured nut and position the captured nut in alignment with a mounting aperture of the mounting feature. An electronics module is disposed within the inline housing.

### BACKGROUND

Industrial Internet of Things (IIoT) is rapidly developing to provide ease of connected instrumentation for monitoring and control of legacy applications and those that have historically been challenging to access. The density and mobility of instrumentation, application type, differences in regulations, data security, sensitivity and sovereignty, and cost-value trade-offs are among the factors that drive the need for a variety of sensing, actuation, and connectivity protocols.

Mounting industrial measurement or network devices can be cumbersome due to the complexity of the mounting hardware needed. The hardware can contain several bolts and/or brackets that need to be assembled which can take several extra minutes per unit being mounted and can require several different tools.

### SUMMARY

An industrial transmitter includes a lower housing having a recess configured to receive an electronics module, the lower housing also having at least one mounting feature formed integrally therein. An electronics module is disposed within the recess. A cover is coupled to the lower housing to hermetically seal the electronics module within the lower housing and the cover.

An industrial transmitter includes an inline housing having a first end and a second end, the inline housing having an integral mounting feature configured to receive a captured nut and position the captured nut in alignment with a mounting aperture of the mounting feature. An electronics module is disposed within the inline housing.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a diagrammatic view of an electronics module and mountable housing in accordance with an embodiment of the present invention.

FIG. 2 is a block diagram of an system in accordance with an embodiment of the present invention.

FIG. 3 is a side elevation view of a housing portion having an improved mounting feature in accordance with an embodiment of the present invention.

FIG. 4 is a diagrammatic view illustrating a mounting process with respect to the housing portion shown in FIG. 3 in accordance with an embodiment of the present invention.

FIG. 5 is a diagrammatic view illustrating another mounting process with respect to the housing portion shown in FIG. 3 in accordance with an embodiment of the present invention.

FIG. 6 is a diagrammatic view illustrating another mounting process with respect to the housing portion shown in FIG. 3 in accordance with an embodiment of the present invention.

FIG. 7 is a diagrammatic perspective view of another housing (inline) with a mounting feature in accordance with an embodiment of the present invention.

FIG. 8 is a diagrammatic rear elevation view of an housing (inline) with a mounting feature in accordance with an embodiment of the present invention.

FIG. 9 is a cross-sectional view of a housing (inline) with a mounting feature in accordance with an embodiment of the present invention.

FIG. 10 is a side elevation view of a housing (inline) with a mounting feature in accordance with an embodiment of the present invention.

FIG. 11 is a rear cross-sectional view of a housing (inline) with a mounting feature in accordance with an embodiment of the present invention.

FIGS. 12 and 13 are diagrammatic views illustrating mounting processes with respect to the housing (inline) in accordance with embodiments of the present invention.

### DETAILED DESCRIPTION OF ILLUSTRATIVE EMBODIMENTS

Industrial Internet of Things (IIoT) adoption is rapidly increasing, creating opportunities for a new class of easy-to-use connected measurement and control instrumentation. These opportunities exist for both legacy measurement applications and for new asset optimization and health monitoring that will help end users run their operations in more efficient, reliable, sustainable, and environmentally friendly ways.

Embodiments described herein generally provide device housings having integral mounting features that simplify the installation process by adapting to several mounting mechanisms or styles. A single mounting bolt or hose clamp/mounting band will attach the device to nearly any existing hardware which will ease the complication of the mounting process while saving a significant amount of time.

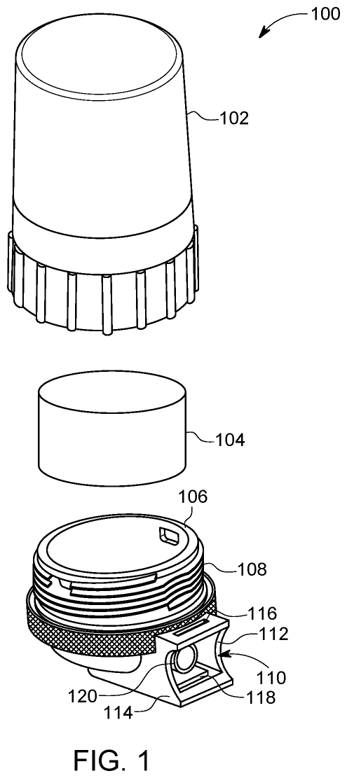

FIG. 1 is a diagrammatic view of an electronics module and mountable housing in accordance with an embodiment of the present invention. System 100 includes a cover 102, electronics module 104, and lower housing 106. Cover 102 is configured, in the illustrated embodiment, to engage external threads 108 on lower housing 106 to form a hermetic seal for electronics module 104. Electronics module 104 can take any suitable shape and size but is generally configured to fit within the chamber formed by cover 102 and lower housing 106. In the illustrated embodiment, electronics module 104 is shaped cylindrically and may include one or more printed circuit boards having suitable electronics components mounted thereon. System 100 can be considered to be an industrial transmitter. As used herein, an industrial transmitter includes measurement, control (actuator) or monitoring devices as well as IIOT devices including gateways and repeaters.

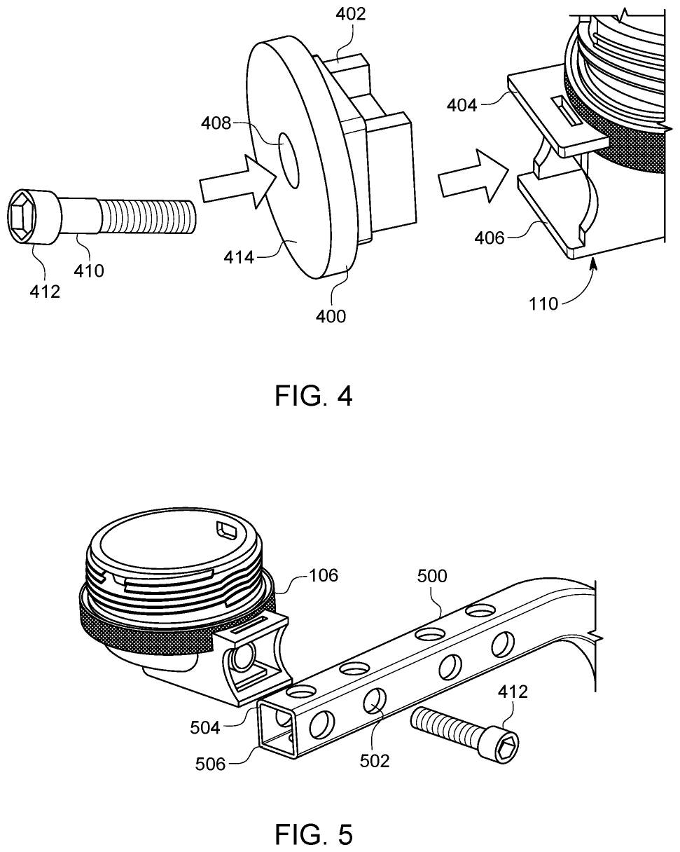

As shown in FIG. 1, lower housing 106 includes at least one mounting feature 110. It is preferred that mounting feature 110 be formed integrally with lower housing 106 for cost and simplicity. Mounting feature 110 includes a pair of arcuate surfaces 112, 114 that are configured to engage a curved surface, such as a pipe or conduit (not shown). Mounting feature 110 also includes a pair of slots 116, 118 that are configured to engage a belt, band or strap that can be wrapped around a physical structure, such as a tank, to mount system 100 thereto. Additionally, mounting feature 110 also includes an internally-threaded aperture 120 that is configure to threadably receive a fastener, such as a bolt, to mount a magnetic coupler (shown in FIG. 4) to the assembly to allow the magnetic coupler to adhere system 100 to any suitable ferromagnetic surface.

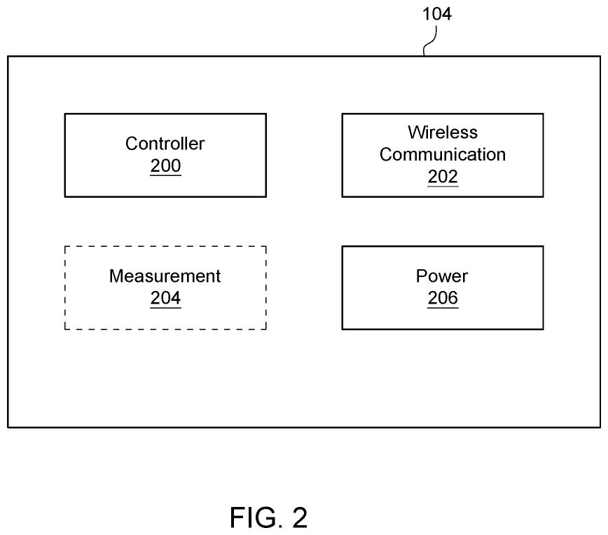

FIG. 2 is a block diagram of an electronics module, with which embodiments of the present invention can be practiced. Electronics module 104 includes controller 200, wireless communication module 202, optional measurement circuitry 204 (illustrated in phantom) and power module 206.

Controller 200 may be any suitable circuitry that is able to execute a number of programmatic steps or functions to communicate with an external device wireless communication module 202. Controller 200 may be an application specific integrated circuit (ASIC), field programmable gate array (FPGA), microcontroller, or microprocessor.

Wireless communication module 202 is configured to interact with controller 200 and to communicate in accordance with one or more standard protocols. Examples of wireless communication protocols include, without limitation, WirelessHART, Cellular (NB-IoT, LTE-M), Wi-Fi, LoRaWAN, and Bluetooth Low Energy. Additionally, wireless communication module 202 may be coupled to a wires connection and configured to communicate in accordance with a wired process communication protocol. Examples of such wired communication include, without limitation, HART, 4-20 mA, FOUNDATION™ Fieldbus, Profibus, Modbus, Ethernet, and Ethernet-APL. In examples where electronics module 104 is not used in conjunction with a sensor, measurement circuitry 204 may be omitted. In such examples, electronics module 104 can still function as a communication repeater, such as a standalone wireless repeater. Additionally, in embodiments where the communication module includes multiple protocol circuits, it may function as a wireless gateway. For example, wireless communication module 202 may receive HART signals via a wired connection and transmit them wirelessly using a suitable wireless communication protocol, such as WirelessHART.

Electronics module 104 includes power management circuitry 206 and provides regulated power to components of electronics module 104. Additionally, power management circuitry 206 can also provide voltage monitoring for battery-operated assemblies.

Electronics module 104 may also include measurement circuitry 204 coupled to controller 200. Measurement circuitry 204 includes suitable circuitry for measuring an analog electrical characteristic (e.g., resistance, voltage, current, et cetera) and providing a digital indication of the measured analog electrical characteristic to controller 200. Suitable examples of circuitry of measurement processing circuitry includes one or more analog-to-digital converters, one or more amplifiers, and or one or more multiplexers or switches. Further, measurement circuitry 204 provides generic sensing of current and/or voltage for any number of applications such as battery monitoring and diagnostic calculations of external power banks. Any suitable type of sensor can be coupled to measurement circuitry 204 including, without limitation, temperature sensors, pressure sensors, level sensors, corrosion sensors, gas detection sensors, or any combination thereof.

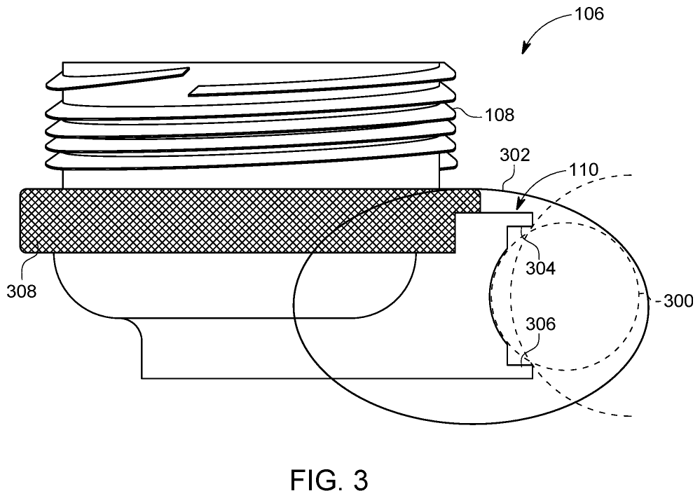

FIG. 3 is a side elevation view of a housing portion having an improved mounting feature in accordance with an embodiment of the present invention. FIG. 3 shows lower housing portion 106 as well as an enlarged view of mounting feature 110 within region 302. As can be seen, arcuate surface 114 is configured to engage a pipe or conduit 300 (shown in phantom). In the illustrated example, mounting feature 110 also includes a pair of internal corners 304, 306 that are configured to receive a rectangular bracket (not shown). FIG. 3 also shows knurled surface 308 helps the user hold lower housing portion 106 while engaging or disengaging cover 102 (shown in FIG. 1).

FIG. 4 is a diagrammatic view illustrating a mounting process with respect to the housing portion shown in FIG. 3 in accordance with an embodiment of the present invention. FIG. 4 shows magnetic coupler 400 being coupled to mounting feature 110 of lower housing 106. Magnetic coupler 400 includes a rectangular block portion 402 that is sized and shaped to be inserted into mounting feature 110. Thus, rectangular block portion 402 fits within tabs 404, 406. Magnetic coupler 400 includes a bore 408 that allows a fastener, such as fastener 410, to pass through magnetic coupler 400 and engage internally-threaded aperture 120 of lower housing 106. Additionally, bore 408 is also counter-bored, such that head 412 of fastener 410 is disposed entirely within aperture 120 and does not protrude beyond surface 414. Surface 414 contains or is formed of a permanent magnet that enables magnetic coupler, when attached to lower housing 106, to mount the system 100 to any suitable ferromagnetic surface.

FIG. 5 is a diagrammatic view illustrating another mounting process with respect to the IIoT housing portion shown in FIG. 3 in accordance with an embodiment of the present invention. FIG. 5 illustrates lower housing 106 being coupled to a mounting bracket 500 using fastener 412. As shown, fastener 412 passes through an aperture 502 in bracket 500 and is received by internally-threaded aperture 120 in lower housing 106. When system 100 is mounted to a bracket, such as bracket 500, corners 504, 506 of bracket 500 preferably abut internal corners 304, 306 (shown in FIG. 3), respectively. This engagement of the corners of bracket 500 with internal corners 304, 306, allows a simply one-bolt mounting method thus simplifying field installation.

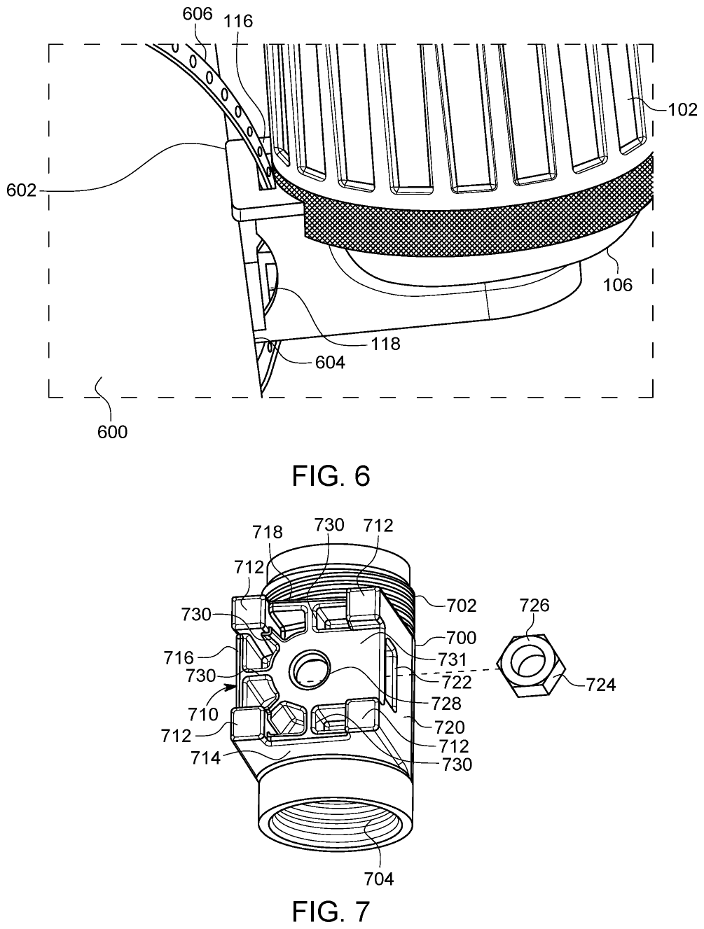

FIG. 6 is a diagrammatic view illustrating another mounting process with respect to the housing portion shown in FIG. 3 in accordance with an embodiment of the present invention. FIG. 6 shows system 100 being mounted to a large diameter surface, such as a large pipe or tank 600. In such applications, lower housing 106 bears directly against the pipe/tank 600 with ends 602, 604 of mounting feature 110 in direct contact with pipe/tank 600. Then, a band 606 is inserted through slot 116 and 118 then wrapped around the structure and returned through the band clamping mechanism. As the band is tensioned (in any suitable manner) ends 602, 604 are pressed firmly against pipe/tank 600.

FIG. 7 is a diagrammatic perspective view of another housing (inline) with a mounting feature in accordance with an embodiment of the present invention. FIG. 7 shows an inline housing 700 that has two threaded regions 702, 704. Housing 700 is considered an inline housing since it is designed to couple directly to the process or process sensor using a direct threaded connection, manifold or seal system. These threaded regions facilitate coupling a cap, such as cap 102 to inline housing 700. Additionally, a sensor module or plug can be threaded to one of the threaded regions 702, 704. The chamber within housing 700 is preferably sized and shaped to hold an electronics module, such as module 104. FIG. 7 also shows inline housing 700 having an integrally-formed mounting feature 710. Mounting feature 710, in the illustrated example, includes four posts 712 that form a support structure for mounting feature 710. Additionally, mounting feature 710 includes three walls 714, 716, and 718 that extend between posts 712. On a fourth side, wall 720 extends between a pair of posts 712 and includes slot 722. Slot 722 is sized to receive nut 724 and has a width that captures nut 724 such that it cannot rotate once inserted into slot 722. Nut 724 is inserted into slot 722 until nut aperture 726 is aligned with mounting aperture 728, at which point a fastener can extend through mounting aperture 728 and engage nut aperture 726. FIG. 7 also shows a number of ribs 730 extending from central mounting region 731 to either walls 714 or posts 712. These ribs add significant strength to the inline housing 700 and are preferably formed integrally with housing 700.

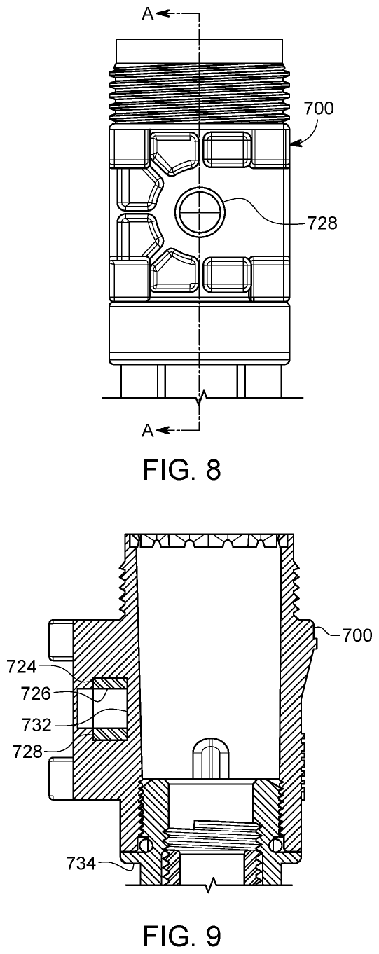

FIG. 8 is a diagrammatic rear elevation view of a housing (inline) with a mounting feature in accordance with an embodiment of the present invention. FIG. 8 shows inline assembly with nut 724 positioned such that nut aperture 726 (shown in FIG. 7) is aligned with mounting aperture 728.

FIG. 9 is a cross-sectional view of housing (inline) 700 taken along section lines A-A in FIG. 8. As can be seen, nut 724 is positioned such that nut aperture 726 is aligned with mounting aperture 728. Additionally, wall 732 creates a blind hole and a stop for a fastener engaged within nut 724. FIG. 9 also shows a portion of a sensing module threaded into IIOT inline housing 700. The sensing module may be any suitable sensing module providing any suitable process variable sensor.

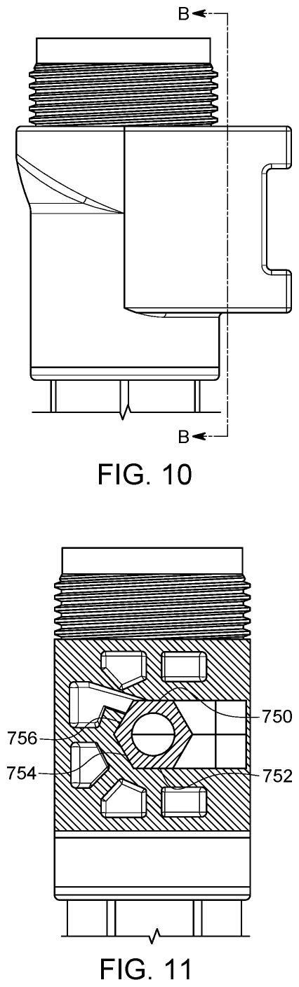

FIG. 10 is a side elevation view of a housing (inline) with a mounting feature in accordance with an embodiment of the present invention. FIG. 11 is a rear cross-sectional view of a housing (inline) taken along section line B-B in FIG. 10. FIG. 11 shows nut 724 captured on four sides 750, 752, 754, and 756. This helps ensure that nut 724 will not rotate as the fastener is tightened. This is particularly important in embodiments where a inline housing 700 is formed of polymer or non-metallic material.

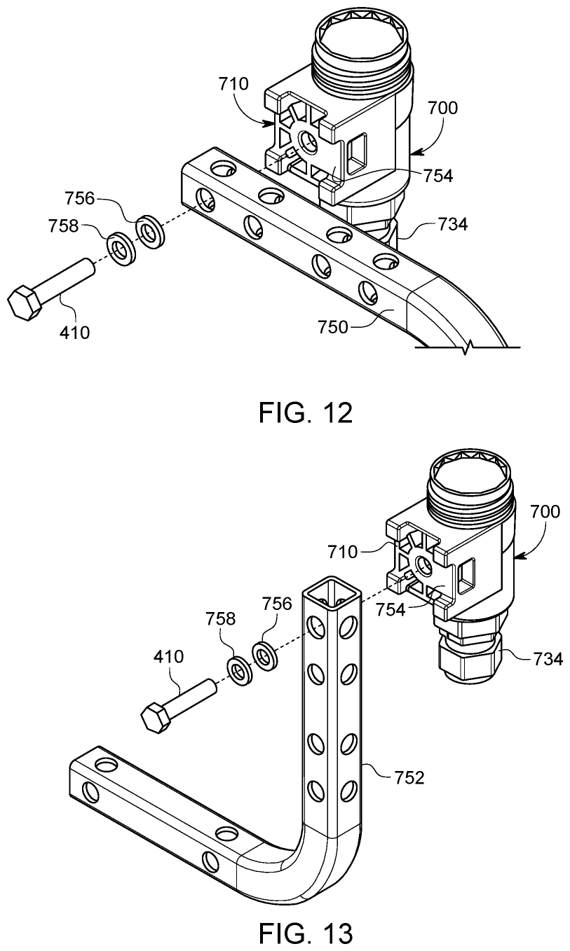

FIGS. 12 and 13 are diagrammatic views illustrating mounting processes with respect to the housing (inline) in accordance with embodiments of the present invention. Inline housing 700 is shown coupled to horizontal bracket 750 in FIG. 12 and coupled to vertical bracket 752 in FIG. 13. In each case, the bracket is placed against mounting feature 710 such that the wall of the bracket is against surface 754 of inline housing 700. As can be seen, posts 712 extend partially around the bracket and provide additional support such that a single fastener, such as fastener 410 can be used to mount the inline housing to the bracket. Preferably, a flat washer 756 and lock washer 758 are used with fastener 410.

Although the present invention has been described with reference to preferred embodiments, workers skilled in the art will recognize that changes may be made in form and detail without departing from the spirit and scope of the invention.

What is claimed is:

1. An industrial transmitter system comprising:
a lower housing having a recess configured to receive an electronics module, the lower housing also having at least one mounting feature formed integrally therein;
an electronics module disposed within the recess; and
a cover coupled to the lower housing to hermetically seal the electronics module within the lower housing and the cover.

2. The system of claim 1, wherein the at least one mounting feature includes a pair of arcuate surfaces configured to engage a pipe.

3. The system of claim 1, wherein the at least one mounting feature includes a pair of internal corners configured to receive a rectangular bracket.

4. The system of claim 1, wherein the at least one mounting feature includes a pair of slots configured to receive a mounting band.

5. The system of claim 1, wherein the at least one includes an internally-threaded mounting aperture.

6. The system of claim 1, and further comprising a magnetic coupler attached to the at least one mounting feature.

7. The system of claim 6, wherein the magnetic coupler includes a rectangular block portion sized and shaped to be inserted into the at least one mounting feature.

8. The system of claim 7, wherein the magnetic coupler includes an aperture sized to pass a fastener.

9. The system of claim 8, wherein the aperture includes a counterbore configured to allow a head of the fastener to sit below a surface of the magnetic coupler.

10. The system of claim 1, wherein the mounting feature is configured to mount the system in accordance with a plurality of different mounting techniques.

11. An industrial transmitter system comprising:
an inline housing having a first end and a second end, the inline housing having an integral mounting feature configured to receive a captured nut and position the captured nut in alignment with a mounting aperture of the mounting feature; and
an electronics module disposed within the inline housing.

12. The system of claim 11, wherein the electronics module includes measurement circuitry.

13. The system of claim 12, and further comprising a sensor module threadably engaged with one of the first and second ends of the inline housing, the sensor module being operably coupled to the measurement circuitry.

14. The system of claim 11, wherein the mounting feature includes a slot configured to receive the captured nut.

15. The system of claim 14, wherein the mounting feature engages a plurality of sides of the captured nut to prevent rotation of the captured nut.

16. The system of claim 15, wherein the mounting feature includes a wall configured to create a blind hole with the mounting aperture.

17. The system of claim 11, wherein the mounting feature includes a plurality of support posts surrounding the mounting aperture.

18. The system of claim 17, and further comprising a wall extending between each pair of adjacent support posts.

19. The system of claim 18, and further comprising a first plurality of ribs extending from a central mounting region of the mounting feature to a given wall.

20. The system of claim 19, and further comprising a second plurality of ribs extending from the central mounting region to a given support post.
